(19) United States
(12) Patent Application Publication
(10) Pub. No.: US 2005/0227715 A1
(43) Pub. Date: Oct. 13, 2005

(54) Low-cost high-power digital cordless telephone architecture

(76) Inventors: Wilhelm Ernst Riedl, Indianapolis, IN (US); David Lee Kechkaylo, Carmel, IN (US); Hung Chi Lai, Indianapolis, IN (US)

Correspondence Address: THOMSON LICENSING INC., PATENT OPERATIONS, PO BOX 5312, PRINCETON, NJ, 08543-5312, US

(21) Appl. No.: 10/524,898

(22) PCT Filed: Aug. 20, 2003
(86) PCT No.: PCT/US03/26016

§ 371 Date: Feb. 17, 2005

(30) Foreign Application Priority Data
Aug. 22, 2002 (US) 60405355

(51) Int. Cl. H04Q 7/20

(52) U.S. Cl. 455/462; 455/403

(57) ABSTRACT

There is provided a digital, non-spread spectrum, cordless telephone that includes a baseband circuit and a transceiver. The baseband circuit consists of non-application specific circuitry. The non-application specific circuitry includes Continuous Variable Slope Delta Modulation (CVSD) circuitry for encoding and decoding voice data. The transceiver has Frequency Division Duplex circuitry for transmitting the voice data at a Radio Frequency (RF) transmit power greater than 0 dbm.

### FIELD OF THE INVENTION

The present invention generally relates to cordless telephones and, more particularly, to a low-cost, high-power digital cordless telephone architecture.

### BACKGROUND OF THE INVENTION

Typically, digital cordless telephones have been implemented using Spread Spectrum Technology (SST) and Time Division Duplex (TDD) Adaptive Delta Pulse Code Modulation (ADPCM) to achieve a higher output power. However, the use of SST and ADPCM requires application-specific circuitry in the baseband circuitry that drives up the overall cost of manufacturing such digital cordless telephones.

Moreover, conventional cordless digital telephones further require costly Digital Signal Processing (DSP) circuitry for resolving a time-delayed echo that results from delays in signal and information processing.

Accordingly, it would be desirable and highly advantageous to have a low-cost, high-power digital cordless telephone that overcomes the above-described deficiencies of the prior art.

### SUMMARY OF THE INVENTION

The problems stated above, as well as other related problems of the prior art, are solved by the present invention, which is directed to a low-cost, high-power digital cordless telephone. Advantageously, the present invention provides a secure digital cordless telephone architecture without the use of costly Spread Spectrum Technology (SST). Moreover, the present invention does away with the need for application-specific circuitry in the baseband circuitry, thereby allowing the use of off-the-shelf components. As is known, off-the-shelf components are typically cheaper and more readily available than application specific circuitry. Further, the present invention does away with the processing delay of information that appears as a time delayed echo to the consumer and, thus, obviates the need for the present invention to employ costly Digital Signal Processing (DSP) circuitry for resolving the echo.

According to an aspect of the present invention, there is provided a digital, non-spread spectrum, cordless telephone that includes a baseband circuit and a transceiver. The baseband circuit consists of non-application specific circuitry. The non-application specific circuitry includes Continuous Variable Slope Delta Modulation (CVSD) circuitry for encoding and decoding voice data. The transceiver has Frequency Division Duplex (FDD) circuitry for transmitting the voice data at a Radio Frequency (RF) transmit power greater than 0 dbm.

According to another aspect of the present invention, there is provided a method for transmitting voice data by a digital cordless telephone. Voice data is encoded using Variable Slop Delta Modulation. The encoded voice data is scrambled using a non Spread Spectrum Technology (SST). The scrambled voice data is transmitted using Frequency Division Duplex (FDD) and at a Radio Frequency (RF) transmit power greater than 0 dbm.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a transmission circuit 100 for a low-cost, high-power digital cordless telephone, according to an illustrative embodiment of the present invention;

FIG. 2 is a flow diagram illustrating a method for transmitting voice data by a digital cordless telephone, according to an illustrative embodiment of the present invention;

FIG. 3 is a block diagram illustrating a reception circuit 300 for a low-cost, high-power digital cordless telephone, according to an illustrative embodiment of the present invention;

FIG. 4 is a flow diagram illustrating a method for transmitting voice data by a digital cordless telephone, according to an illustrative embodiment of the present invention; and

FIG. 5 is a schematic diagram illustrating a baseband circuit 500 for a digital cordless telephone having a handset and a base unit, according to an illustrative embodiment of the present invention.

### DETAILED DESCRIPTION OF THE INVENTION

The present invention is directed to a low-cost, high-power digital cordless telephone having a handset and a base unit. The present invention provides a secure communication path between a handset and a base unit without the use of Spread Spectrum Technology (SST) and Adaptive Delta Pulse Code Modulation (ADPCM), thus obviating the need for costly application-specific circuitry (e.g., an Application Specific Integrated Circuit (ASIC)) in the baseband circuitry as required by the prior art. As such, the baseband circuitry of the present invention may advantageously be implemented using only off-the-shelf components.

Further, the present invention utilizes Frequency Division Duplex (FDD) to obtain a better link budget for a given power output over Time Division Duplex (TDD). Moreover, the present invention utilizes Continuously Variable Slope Delta Modulation (CVSD) encoding to provide better performance for a given minimum Bit Error Rate (BER) compared to presently existing SST systems. The utilization of CVSD eliminates the need for framing the data and, thus, results in lower implementation costs.

The present invention utilizes scrambling technology to make the spectral characteristics more noise-like which, coupled together with a high modulation index in the transmit Frequency Shift Keying (FSK) modulator, results in a digital cordless telephone that satisfies Federal Communications Commission (FCC) requirements such as, for example, FCC Part 15 rule change, dated April 2002.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

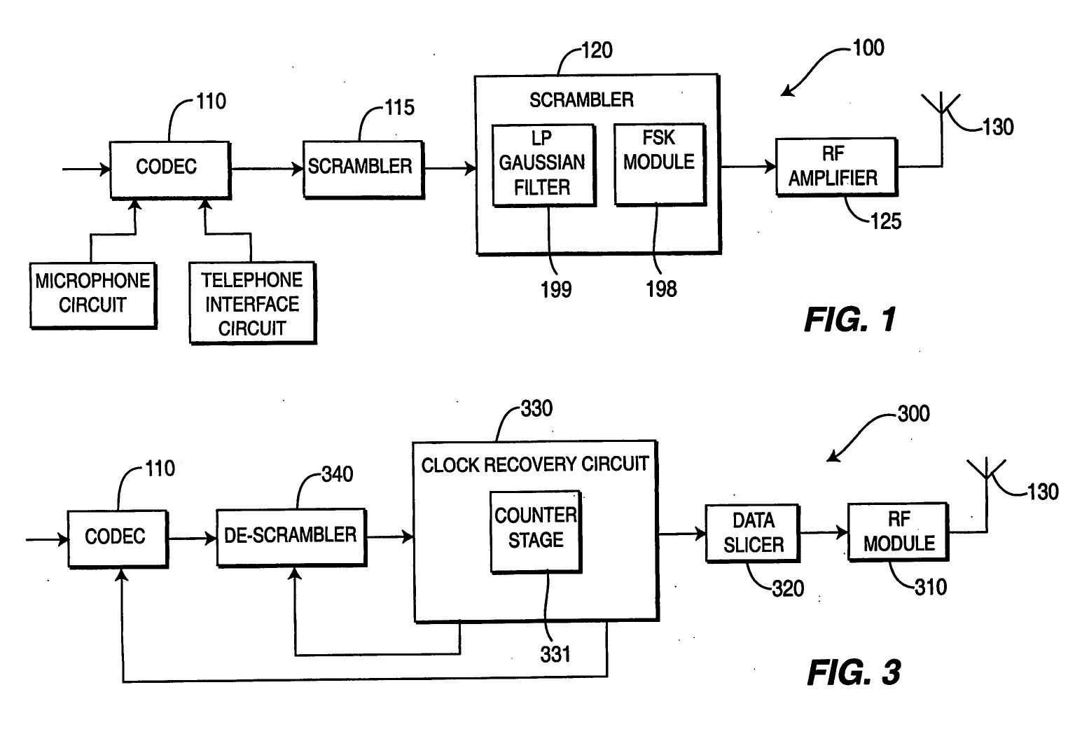

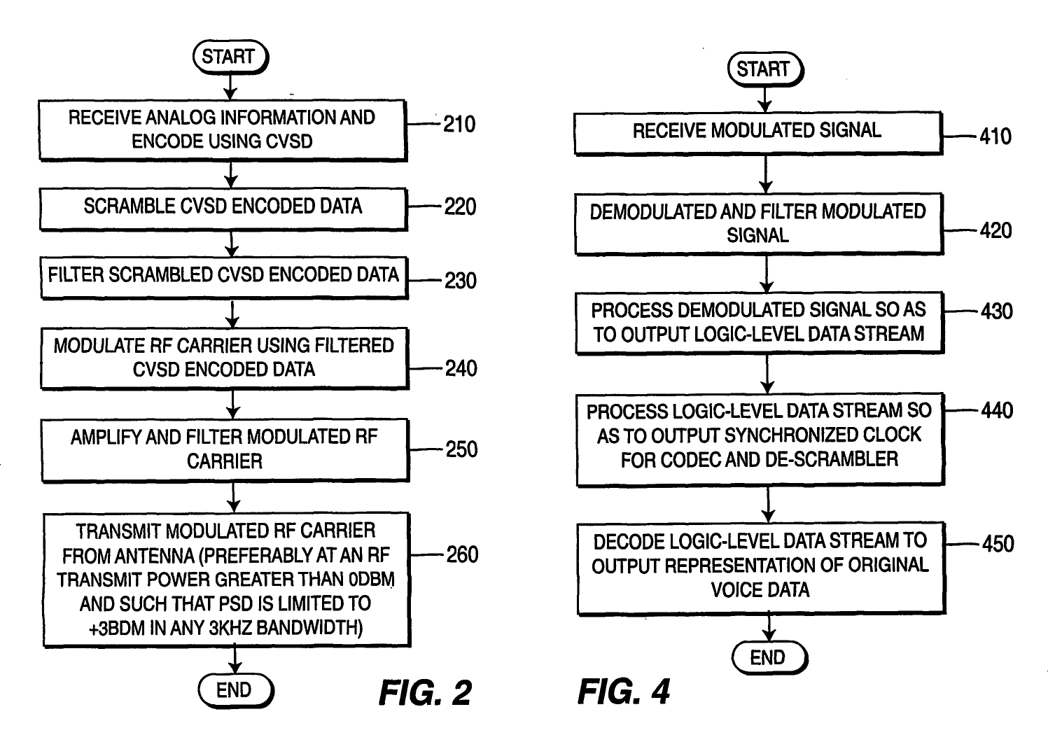

A brief description will now be given of modifications made to an existing digital cordless telephone to enable operation thereof in accordance with the present invention. More detailed descriptions follow with respect to FIGS. 1 and 2 regarding a transmission circuit and a reception circuit, respectively, for a digital cordless telephone according to the present invention. Thereafter, a description is provided of an implementation of a baseband circuit of a digital cordless telephone with respect to FIG. 3, such that the baseband circuit includes only off-the-shelf components and does not include any application specific circuitry or components such as, for example, Application Specific Integrated Circuits (ASICs).

For illustrative purposes, a digital cordless telephone according to an illustrative embodiment of the present invention was created by modifying an existing analog 2.4 GHz cordless telephone. The cordless telephone included a handset and a base unit, both having a baseband circuit that included a receiver portion and a transmitter portion for respectively receiving and transmitting voice data.

The modifications included changing the analog baseband circuitry to incorporate the CVSD encoding and decoding functions as well as clock recovery and scrambling/de-scrambling functions described in further detail below. The CVSD encoding and decoding functions were incorporated into a codec Integrated Circuit (IC).

The modifications to the receiver portion included widening the Intermediate Frequency (IF) and the detector bandwidth of the Radio Frequency (RF) section of the receiver portion. Further, the modifications to the transmitter portion included adding a Gaussian data filter before the Frequency Modulation (FM) modulator. The CVSD data stream was scrambled before filtering and the Transmission (TX) spectrum was measured. It was found that the TX spectrum was well within the FCC requirements specified by FCC Part 15 rule change, dated April 2002, even if the cordless telephone where to operate at the maximum allowed FCC level of one watt. FCC Part 15 rule change, dated April 2002 is incorporated by reference herein.

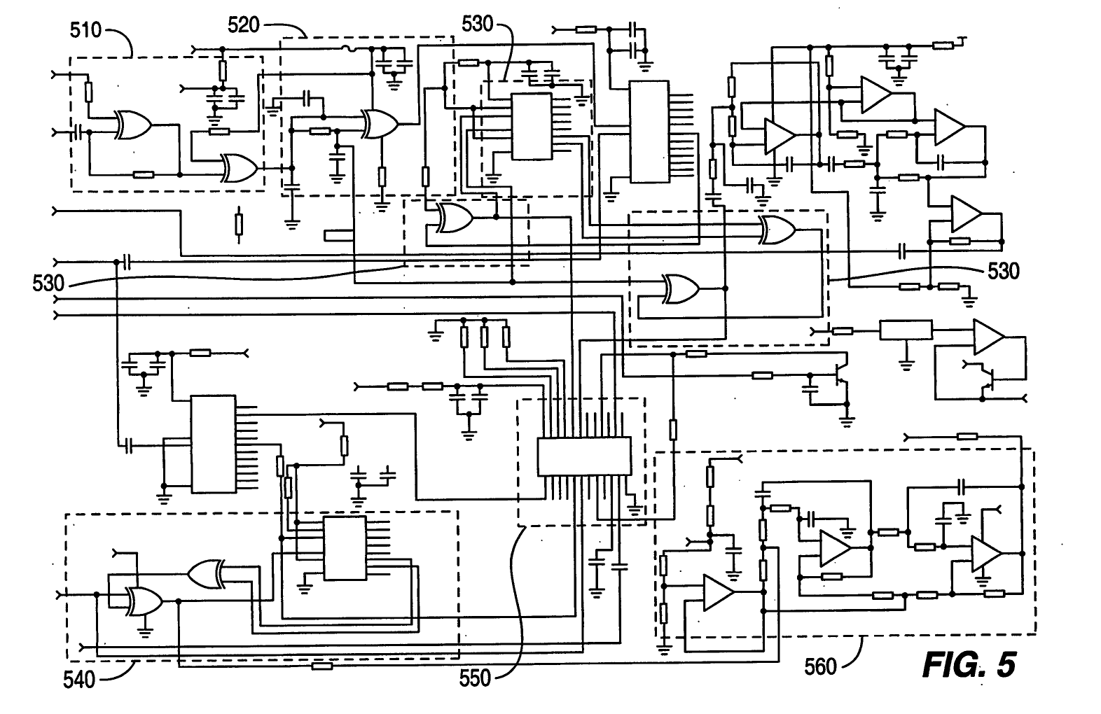

Referring back to the receiver portion, the demodulated signal from a detector portion of a Radio Frequency (RF) module was sliced using a comparator and then the demodulated signal was Exclusive-ORed (XOR-ed) with a delayed version of itself. The time delay was accomplished with a Resistor-Capacitor (RC) circuit with the proper time constant. The proper time constant is derived on the order of the master clock period. As an example, with respect to the baseband circuit 500 of FIG. 5 described below, the 4 MHz system clock is divided down to 62.5 KHz to provide the data clock. The resulting delayed and XOR-ed demodulated signal, which now represents the data edges of the receiver voice data, was used to reset a frequency divider that counted the system clock down for clock recovery. This recovered clock signal was then utilized for both a de-coding clock of the CVSD Integrated Circuit (IC) and a shift clock for the self-synchronizing de-scrambler. The scrambler/de-scrambler was realized using a polynomial generator using a seven-stage shift-register and XOR gates. The scrambler/de-scrambler is self-synchronizing. Of course, the present invention is not limited to solely cordless telephones having the above structure and, thus, may be implemented with respect to digital cordless telephones having other structures. For example, in other embodiments of the present invention, the scrambler/de-scrambler may have more or less than seven stages, receiver and transmitter functions may be collectively performed by a transceiver, and so forth.

FIG. 1 is a block diagram illustrating a transmission circuit 100 for a low-cost, high-power digital cordless telephone, according to an illustrative embodiment of the present invention. The transmission circuit 100 includes a codec 110, a scrambler 115, a Frequency Modulation (FM) modulator 120, a Radio Frequency (RF) amplifier 125, and an antenna 130. The transmission circuit 100 is preferably part of a baseband circuit of the digital cordless telephone.

FIG. 2 is a flow diagram illustrating a method for transmitting voice data by a digital cordless telephone, according to an illustrative embodiment of the present invention. The method of FIG. 2 may be practiced using the transmission circuit 100 of FIG. 1.

Analog information is received by the codec 110 from either a microphone circuit 199 in the handset or from a telephone interface circuit 198 in the base unit (depending upon whether the transmission circuit 100 is implemented in the handset or the base unit), and is encoded into a digital data stream using Continuously Variable Slope Delta Modulation (CVSD) (step 210). The resultant output of the codec 110 is a CVSD encoded digital data stream.

The CVSD encoded digital data stream is scrambled by the scrambler 115 (step 220). The scrambler 115 may scramble the CVSD encoded digital data stream by, for example, permuting the inputted data bits using a pseudo-random user-defined method. Preferably, the scrambler 115 is capable of self-synchronizing de-scrambling.

The FM modulator 120 includes a low-pass Gaussian filter 121 and a Frequency Shift Keying (FSK) module 122. The scrambled CVSD encoded digital data stream output from the scrambler 115 is filtered by the low-pass Gaussian filter 121 filters so as to output a filtered signal confined within a pre-designated Radio Frequency (RF) channel bandwidth (step 230). The filtered signal is then directly applied to the FSK module 122 to modulate a high RF carrier. Preferably, the high RF carrier is modulated by the FSK module 122 using a high deviation ratio (step 240).

The modulated RF carrier is amplified and filtered by the RF amplifier 125 (step 250), and is then transmitted from the antenna 130 using Frequency Division Duplex (step 260). Preferably, the modulated RF carrier is transmitted at an RF transmit power greater than 0 dbm. Moreover, it is preferable that the Power Spectral Density (PSD) of the modulated RF carrier is limited to +8 dbm in any 3 kHz bandwidth.

FIG. 3 is a block diagram illustrating a reception circuit 300 for a low-cost, high-power digital cordless telephone, according to an illustrative embodiment of the present invention. The reception circuit 300 includes an antenna 130, a Radio Frequency (RF) module 310, a data slicer 320, a clock recovery circuit 330, a de-scrambler 340, and a codec 110. The reception circuit 300 is preferably part of a baseband circuit of the digital cordless telephone.

The Incoming demodulated data, after being squared up using the data slicer 320, is XORed with a time-delayed version of itself. This process results in a signal that represents a waveform that includes narrow pulses that occur each time the data signal changes state (either from High to Low or from Low to High). The width of these pulses equals the amount of time delay used to generate the pulses. These pulses are aligned in time with the data edges and, therefore, provide the timing reference used to synchronize the receive data clock. This is accomplished by resetting the master counter that takes the 4 MHz system clock and divides down to 62.5 KHz. This reset occurs each time that the received data stream changes state and therefore synchronizes the receive clock to the data stream.

FIG. 4 is a flow diagram illustrating a method for transmitting voice data by a digital cordless telephone, according to an illustrative embodiment of the present invention. The method of FIG. 4 may be practiced using the reception circuit 300 of FIG. 3.

A modulated signal is received by the antenna 130 (step 410), and demodulated and filtered by the Radio Frequency (RF) module 310 (step 420). The demodulated signal is sent through the data slicer 320 so as to output a logic-level data stream (step 430). The data slicer 320 includes a one-bit Analog-to-Digital Converter (ADC).

In a preferred embodiment of the present invention, the data slicer 320 is implemented using CMOS gates operating in the linear region and used as amplifiers to logic levels. The incoming signal is AC coupled into an inverter gate (re-used XOR gate with one input pulled high) with negative feedback in order to establish an operating point for the CMOS gates. This self-bias results in a threshold level around which the gate operates on the data signal with very high gain. This results in a squared-up (to logic levels) signal at the output. The signal is further inverted using another gate to re-establish the original data polarity.

The resulting logic-level data stream output from the data slicer 320 is sent through the clock recovery circuit 330 for processing so as to output a synchronized clock for the codec 110 and the de-scrambler 340 (step 440). The clock recovery circuit 330 performs an Exclusive-OR (XOR) logic operation on the original data and a time-delayed version of the original data to create a signal that consists of only short pulses aligned with the rising and falling data edges of the received signal. These pulses are used to reset a counter stage 331 in the clock recovery circuit 330 that is dividing the receiver's clock. As noted above, the resulting synchronized clock is used to provide the re-covered clock signal for the codec 110 and the de-scrambler 340.

The signal output of the decoder portion of the codec 110 furnishes an analog signal representing the original voice signal (step 450). The analog signal may be further amplified and processed for utilization for the telephone line or the handset speaker (not shown).

FIG. 5 is a schematic diagram illustrating a baseband circuit 500 for a digital cordless telephone having a handset and a base unit, according to an illustrative embodiment of the present invention. The baseband circuit 500 may be implemented in the handset and/or the base unit.

The baseband circuit 500 includes a data slicer 510, a clock recovery module 520, a de-scrambler 530, a scrambler 540, a codec 550 (for both transmission and reception), and a pre-modulation filter 560. The data slicer 510, clock recovery module 520, and de-scrambler 530 correspond to a reception portion of the baseband circuit 500. The scrambler 540 and the pre-modulation filter 560 correspond to a transmission portion of the baseband circuit 500. The codec 550 corresponds to both the reception and transmission portions of the baseband circuit 500. The pre-modulation filter 560 may be implemented as a Gaussian type filter, as mentioned above.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A digital, non spread spectrum, cordless telephone, comprising:
a baseband circuit consisting of non-application specific circuitry, the non-application specific circuitry including Continuous Variable Slope Delta Modulation (CVSD) circuitry for encoding and decoding voice data; and
a transmitter having Frequency Division Duplex (FDD) circuitry for transmitting the voice data at a Radio Frequency (RF) transmit power greater than 0 dbm.

2. The digital cordless telephone of claim 1, wherein said transmitter limits the Power Spectral Density (PSD) of voice data transmissions to +8 dbm in any 3 kHz bandwidth.

3. The digital cordless telephone according to claim 1, wherein said baseband circuit further comprises:
a self-synchronizing scrambler for scrambling the voice data; and
a self-synchronizing de-scrambler for unscrambling the voice data.

4. The digital cordless telephone according to claim 1, wherein said scrambler and de-scrambler each comprise a polynomial generator.

5. The digital cordless telephone according to claim 1, wherein said baseband circuit further comprises a clock recovery circuit for generating a clock recovery signal based on an Exclusive-OR logic operation performed on the voice data and a time-delayed version of the voice data, the clock recovery signal consisting of a plurality of pulses aligned with rising and falling edges of the voice data.

6. The digital cordless telephone according to claim 1, wherein said transmitter complies with Federal Communications Commission (FCC) Part 15 rule change.

7. A method for transmitting voice data by a digital cordless telephone, comprising the steps of:
encoded voice data using Variable Slop Delta Modulation;
scrambling the encoded voice data using a non Spread Spectrum Technology (SST); and
transmitting the scrambled voice data using Frequency Division Duplex (FDD) and at a Radio Frequency (RF) transmit power greater than 0 dbm.

8. The method of claim 7, wherein said transmitting step limits the Power Spectral Density (PSD) of the transmitted scrambled voice data to +8 dbm in any 3 kHz bandwidth.

9. The method of claim 7, wherein said transmitting step complies with Federal Communications Commission (FCC) Part 15 rule change.
